(19) United States
(12) Patent Application Publication
(10) Pub. No.: US 2026/0350900 A1
(43) Pub. Date: Nov. 5, 2026

(54) SYSTEMS AND METHODS FOR DISPLAYING IMAGES BY TRANSFORMING IMAGE PIXEL COORDINATES TO A COMMON COORDINATE SYSTEM

(71) Applicant: Optum, Inc., Minnetonka, MN (US)

(72) Inventors: David Dubois, Mirabel (CA); Paul Vial, Vancouver (CA); Sara Daneshvar, Port Moody (CA)

(21) Appl. No.: 19/195,835

(22) Filed: May 1, 2025

(51) Int. Cl. G06T 15/00; G06T 3/40; G06T 7/13; G06V 10/25

(52) U.S. Cl. CPC G06T 15/00; G06T 3/40; G06T 7/13; G06V 10/25; G06T 2207/30196

(57) ABSTRACT

A computer-implemented method includes receiving a first volumetric object comprising a first set of images, a subset of the first volumetric object comprising a first region of interest, pixels of the first set of images being associated with a first imaged region coordinate system; receiving a second volumetric object comprising a second set of images, a subset of the second volumetric object comprising a second region of interest, pixels of the second set of images being associated with a second imaged region coordinate system; transforming first pixel coordinates of the first region of interest to generate transformed first pixel coordinates based on the first pixel coordinates of the first region of interest and second pixel coordinates of the second region of interest; and displaying first pixels of the first region of interest using the transformed first pixel coordinates.

### FIELD OF INVENTION

The present disclosure relates generally to image processing systems and methods.

### BACKGROUND

Comparing two images may be difficult when the images are taken at different times due to the pixels in the images being associated with different coordinate systems. For example, in the field of health care, a medical practitioner may want to compare an image of a body part with previous images of the body part or other images of the same or similar body part from patient studies. Because the different images may use different coordinate systems for their pixels, a medical practitioner may need to manually navigate to the region of interest in the different images. Images can be registered with one another to facilitate the ability to track to the same or similar locations in the different images, but this is typically a manual process where landmarks in the images are located via manual navigation and associated with each other. Some tools exist that can assist in the manual registration of images with each other, but these tools still typically require manual navigation to landmarks in the respective images.

### SUMMARY

According to some embodiments of the disclosure, a computer-implemented method comprises: receiving, by one or more processors, a first volumetric object comprising a first set of images, a subset of the first volumetric object comprising a first region of interest associated with at least a subset of the first set of images, pixels of the first set of images being associated with a first imaged region coordinate system; receiving, by the one or more processors, a second volumetric object comprising a second set of images, a subset of the second volumetric object comprising a second region of interest associated with at least a subset of the second set of images, pixels of the second set of images being associated with a second imaged region coordinate system; determining, by the one or more processors, that a first vertex of the first region of interest is within the first imaged region coordinate system and a second vertex of the second region of interest is within the second imaged region coordinate system; determining, by the one or more processors, that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively; transforming, by the one or more processors, first pixel coordinates of the first region of interest to generate transformed first pixel coordinates based on the first pixel coordinates of the first region of interest and second pixel coordinates of the second region of interest; and displaying, by the one or more processors, first pixels of the first region of interest using the transformed first pixel coordinates.

In other embodiments, the combination of the first region of interest and the second region of interest includes complete edges in three dimensions that are within the first imaged region coordinate system or the second imaged region coordinate system, respectively; wherein transforming the first pixel coordinates of the first region of interest comprises: multiplying, by the one or more processors, a matrix containing the first pixel coordinates by a transformation matrix.

In still other embodiments, the transformation matrix is a product of an inverse of a matrix containing the second pixel coordinates and the matrix containing the first pixel coordinates; and wherein displaying the first pixels of the first region of interest comprises: displaying, by the one or more processors, the first pixels of the first region of interest using the transformed first pixel coordinates and second pixels of the second region of interest using the second pixel coordinates of the second region of interest.

In still other embodiments, the first region of interest or the second region of interest includes the complete edge in one of the three dimensions that is within the first imaged region coordinate system or the second imaged region coordinate system; wherein transforming the first pixel coordinates of the first region of interest comprises: determining, by the one or more processors, a generic imaged region coordinate system; determining, by the one or more processors, a first transformation matrix that maps coordinates from the first imaged region coordinate system to the generic imaged region coordinate system; determining, by the one or more processors, a second transformation matrix that maps coordinates from the second imaged region coordinate system to the generic imaged region coordinate system; and determining, by the one or more processors, a third transformation matrix as a product of an inverse of the second transformation matrix and the first transformation matrix.

In still other embodiments, transforming the first pixel coordinates of the first region of interest comprises: scaling, by the one or more processors, the first pixel coordinates of the first region of interest; multiplying, by the one or more processors, a matrix containing the scaled first pixel coordinates by the third transformation matrix.

In still other embodiments, displaying the first pixels of the first region of interest comprises: displaying, by the one or more processors, the first pixels of the first region of interest and second pixels of the second region of interest simultaneously on a same display.

In still other embodiments, the computer-implemented method further comprises: detecting, by the one or more processors and using a machine learned system, the first region of interest in the first volumetric object; generating, by the one or more processors, a first bounding box for the first region of interest; determining, by the one or more processors, the first pixel coordinates based on the first bounding box; detecting, by the one or more processors and using the machine learned system, the second region of interest in the second volumetric object; generating, by the one or more processors, a second bounding box for the second region of interest; and determining, by the one or more processors, the second pixel coordinates based on the second bounding box.

In still other embodiments, the first region of interest and the second region of interest are a same type of region.

In still other embodiments, the type of region is a human body part.

According to some embodiments of the disclosure, a system comprises one or more processors; and one or more memories storing process-executable instructions that, when executed by the one or more processors, cause the one or more processors to perform operations comprising: receiving a first volumetric object comprising a first set of images, a subset of the first volumetric object comprising a first region of interest associated with at least a subset of the first set of images, pixels of the first set of images being associated with a first imaged region coordinate system; receiving a second volumetric object comprising a second set of images, a subset of the second volumetric object comprising a second region of interest associated with at least a subset of the second set of images, pixels of the second set of images being associated with a second imaged region coordinate system; determining that a first vertex of the first region of interest is within the first imaged region coordinate system and a second vertex of the second region of interest is within the second imaged region coordinate system; determining that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively; transforming first pixel coordinates of the first region of interest to generate transformed first pixel coordinates based on the first pixel coordinates of the first region of interest and second pixel coordinates of the second region of interest; and displaying first pixels of the first region of interest using the transformed first pixel coordinates.

In further embodiments, the combination of the first region of interest and the second region of interest includes complete edges in three dimensions that are within the first imaged region coordinate system or the second imaged region coordinate system, respectively; wherein transforming the first pixel coordinates of the first region of interest comprises: multiplying a matrix containing the first pixel coordinates by a transformation matrix.

In still further embodiments, the transformation matrix is a product of an inverse of a matrix containing the second pixel coordinates and the matrix containing the first pixel coordinates; and wherein displaying the first pixels of the first region of interest comprises: displaying the first pixels of the first region of interest using the transformed first pixel coordinates and second pixels of the second region of interest using the second pixel coordinates of the second region of interest.

In still further embodiments, the first region of interest or the second region of interest includes the completed edge in one of the three dimensions that is within the first imaged region coordinate system or the second imaged region coordinate system; wherein transforming the first pixel coordinates of the first region of interest comprises: determining a generic imaged region coordinate system; determining a first transformation matrix that maps coordinates from the first imaged region coordinate system to the generic imaged region coordinate system; determining a second transformation matrix that maps coordinates from the second imaged region coordinate system to the generic imaged region coordinate system; and determining a third transformation matrix as a product of an inverse of the second transformation matrix and the first transformation matrix.

In still further embodiments, transforming the first pixel coordinates of the first region of interest comprises: scaling the first pixel coordinates of the first region of interest; and multiplying a matrix containing the scaled first pixel coordinates by the third transformation matrix.

In still further embodiments, displaying the first pixels of the first region of interest comprises: displaying the first pixels of the first region of interest and second pixels of the second region of interest simultaneously on a same display.

According to some embodiments of the disclosure, one or more non-transitory computer-readable media store processor-executable instructions that, when executed by one or more processors, cause the one or more processors to perform operations comprising: receiving a first volumetric object comprising a first set of images, a subset of the first volumetric object comprising a first region of interest associated with at least a subset of the first set of images, pixels of the first set of images being associated with a first imaged region coordinate system; receiving a second volumetric object comprising a second set of images, a subset of the second volumetric object comprising a second region of interest associated with at least a subset of the second set of images, pixels of the second set of images being associated with a second imaged region coordinate system; determining that a first vertex of the first region of interest is within the first imaged region coordinate system and a second vertex of the second region of interest is within the second imaged region coordinate system; determining that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively; transforming first pixel coordinates of the first region of interest to generate transformed first pixel coordinates based on the first pixel coordinates of the first region of interest and second pixel coordinates of the second region of interest; and displaying first pixels of the first region of interest using the transformed first pixel coordinates.

In other embodiments, the combination of the first region of interest and the second region of interest includes complete edges in three dimensions that are within the first imaged region coordinate system or the second imaged region coordinate system, respectively; wherein transforming the first pixel coordinates of the first region of interest comprises: multiplying a matrix containing the first pixel coordinates by a transformation matrix.

In still other embodiments, the transformation matrix is a product of an inverse of a matrix containing the second pixel coordinates and the matrix containing the first pixel coordinates; and wherein displaying the first pixels of the first region of interest comprises: displaying the first pixels of the first region of interest using the transformed first pixel coordinates and second pixels of the second region of interest using the second pixel coordinates of the second region of interest.

In still other embodiments, the first region of interest or the second region of interest includes the completed edge in one of the three dimensions that is within the first imaged region coordinate system or the second imaged region coordinate system; wherein transforming the first pixel coordinates of the first region of interest comprises: determining a generic imaged region coordinate system; determining a first transformation matrix that maps coordinates from the first imaged region coordinate system to the generic imaged region coordinate system; determining a second transformation matrix that maps coordinates from the second imaged region coordinate system to the generic imaged region coordinate system; and determining a third transformation matrix as a product of an inverse of the second transformation matrix and the first transformation matrix.

In still other embodiments, transforming the first pixel coordinates of the first region of interest comprises: scaling the first pixel coordinates of the first region of interest; and multiplying a matrix containing the scaled first pixel coordinates by the third transformation matrix.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the disclosure will be or become apparent to one with skill in the art upon review of the following drawings and detailed description. It is intended that all such additional systems, methods, articles of manufacture, and/or computer program products be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a system for displaying images by transforming image pixel coordinates to a common coordinate system in accordance with some embodiments of the disclosure;

FIG. 2 is a block diagram that illustrates the machine-learned model for detecting an object in an image in accordance with some embodiments of the disclosure;

FIG. 3-5 are flowcharts that illustrate operations for transforming image pixel coordinates to a common coordinate system in accordance with some embodiments of the disclosure;

FIGS. 6 and 7 are block diagrams that illustrate transforming image pixel coordinates to a common coordinate system in accordance with some embodiments of the disclosure;

FIGS. 8A, 8B, and 8C are block diagrams that illustrate displaying objects in which one of the objects has image pixel coordinates that have been transformed to a common coordinate system in accordance with some embodiments of the disclosure;

FIG. 9 is a data processing system that may be used to implement a system for displaying images by transforming image pixel coordinates to a common coordinate system in accordance with some embodiments of the disclosure;

FIG. 10 is a block diagram that illustrates a software/hardware architecture for use in a system for displaying images by transforming image pixel coordinates to a common coordinate system in accordance with some embodiments of the disclosure; and

FIG. 11A-11E are block diagrams that illustrate example regions of interest in imaged regions associated with different studies in accordance with some embodiments of the disclosure.

### DETAILED DESCRIPTION

In the following detailed description, numerous specific details are set forth to provide a thorough understanding of embodiments of the disclosure. However, it will be understood by those skilled in the art that embodiments of the disclosure may be practiced without these specific details. In some instances, well-known methods, procedures, components, and circuits have not been described in detail so as not to obscure the disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “provider” may mean any person or entity involved in providing health care products and/or services to a patient.

Embodiments of the disclosure are described herein in the context of an Artificial Intelligence (AI) machine-learned model for detecting an object in an image. The machine-learned model may be embodied in a variety of different ways including, but not limited to, one or more of the following AI systems: a multi-layer neural network, a machine learning system, a deep learning system, a large language model, a natural language processing system, and/or computer vision system. Moreover, it will be understood that the multi-layer neural network is a multi-layer artificial neural network comprising artificial neurons or nodes and does not include a biological neural network comprising real biological neurons. The machine-learned model described herein may be configured to transform a memory of a computer system to include one or more data structures, such as, but not limited to, arrays, extensible arrays, linked lists, binary trees, balanced trees, heaps, stacks, and/or queues. These data structures can be configured or modified through the adjudication process and/or the AI training process to improve the efficiency of a computer system when the computer system operates in an inference mode to make an inference, prediction, classification, suggestion, or the like with respect to detecting an object in an image.

Some embodiments of the disclosure stem from a realization that when comparing images taken at different time, it may be difficult to display a common or same object or area of interest due to the pixels in the images being associated with different coordinate systems. As a result, manual navigation may be required in one or more of the images so that the same object or area of interest can be displayed together for comparison. For example, in the field of health care, a provider may want to compare two images of a patient's body part of an image of a patient's body part with other images of the same body part from a study. As these images may be all taken at different times, they may use different coordinate systems for the image pixels, which may result in the provider needing to manually navigate over the different images so that the same body part of region of interest can be displayed together for review and comparison.

Some embodiments of the disclosure may provide systems and methods for displaying images by transforming image pixel coordinates to a common coordinate system. Two objects may be received including a first volumetric object comprising a first set of images where a subset of the first volumetric object comprises a first region of interest associated with at least a subset of the first set of images and a second volumetric object comprising a second set of images where a subset of the second volumetric object comprises a second region of interest associated with at least a subset of the second set of images. Pixels of the first set of images are associated with a first imaged region coordinate system and pixels of the second set of images are associated with a second imaged region coordinate system. To display the first and second regions of interest using a common coordinate system, a vertex of the first region of interest must be within the first imaged region coordinate system and a vertex of the second imaged region coordinate system must be within the second imaged region coordinate system. The pixel coordinates of the first region of interest and/or the pixel coordinates of the second region of interest may be transformed to allow for the first and second regions of interest to be displayed together if either of the two following conditions are satisfied: 1) a combination of the first region of interest and the second region of interest includes complete edges in three dimensions that are within the first imaged region coordinate system or the second imaged region coordinate system, respectively; and 2) the first region of interest or the second region of interest incudes a complete edge in one of the three dimensions that is within the first imaged region coordinate system or the second imaged region coordinate system, respectively. If a combination of the first region of interest and the second region of interest includes complete edges in three dimensions that are within the first imaged region coordinate system or the second imaged region coordinate system, respectively, then the first pixel coordinates of the first region of interest may be multiplied by a transformation matrix to transform the first pixel coordinates of the first region of interest from the first imaged region coordinate system to the second imaged region coordinate system. If the first condition is not satisfied, but the first region of interest or the second region of interest incudes a complete edge in one of the three dimensions that is within the first imaged region coordinate system or the second imaged region coordinate system, respectively, then a generic coordinate system may be determined. For example, a first transformation matrix may be determined that maps coordinates from the first imaged region coordinate system to the generic coordinate system. A second transformation matrix may be determined that maps coordinates from the second imaged region coordinate system to the generic coordinate system. A third transformation matrix is determined as a product of an inverse of the second transformation matrix and the first transformation matrix. The first coordinates may be transformed by multiplying a matrix containing the first coordinates by the third transformation matrix. The first pixel coordinates of the first region of interest may be scaled and then multiplied by the third transformation matrix for display.

Advantageously, by transforming the first coordinates of first pixels of a first region of interest of a first volumetric object to use a second coordinate system of second pixels of a second region of interest of a second volumetric object, the processing time for navigating within the image to locate a common object or region of interest for comparison may be reduced.

In some embodiments, a machine-learned model may be used to detect a region of interest within a volumetric object and to generate a bounding box for the region of interest that defines the coordinates of the region of interest. Advantageously, this may allow the system to reduce the processing time in both navigating to a desired region of interest in an imaged region and in selecting a region of interest for comparison with another region of interest, for example, among multiple imaged regions that may or may not contain a region of interest for comparison.

According to some embodiments of the disclosure, the features used during the training of the machine-learned model for detecting a region of interest in a volumetric object comprising a set of images may be evaluated and one or more of the features with a lesser relative impact on region of interest detection than other features may be removed as part of a model sparsification process during both training and inference mode to sparsify the machine-learned model. When the machine-learned model for detecting an object in an image comprises a neural network, one or more nodes or paths may be removed based on the elimination of one or more features. Advantageously, sparsification of the machine-learned model may allow the model to execute using less memory and reduced computational requirements.

Advantageously, one or more of the features used in training or during inference mode of the machine-learned model for detecting a region of interest in a volumetric object comprising a set of images may be selected to have different quantization levels, e.g., 64-bit, 32-bit, etc. to reduce the size and complexity of the machine-learned model. For example, the quantization level for representing the various features of an object of an image may be varied based on a level of precision required in distinguishing an object from other objects or background noise.

Displaying images, such as positron emission tomography (PET) and/or computed tomography (CT) images. may involve registering images with one another and mapping different modalities in the images to each other. Such an approach may be processor and computing resource intensive, and the display of the images may be slow. Advantageously, embodiments of the disclosure for displaying images by transforming image pixel coordinates to a common coordinate system may provide a coarser correlation between the images, but may reduce the processing and computing resources used in registering images with one another, which may, for example, allow studies to be quickly compared with one another.

Although embodiments of the disclosure are described herein by way of example with respect to a health care provider comparing body parts of regions of interest on a display, it will be understood that the embodiments of the disclosure are applicable generally to transforming image pixels for objects that use different coordinate systems to a common coordinate system.

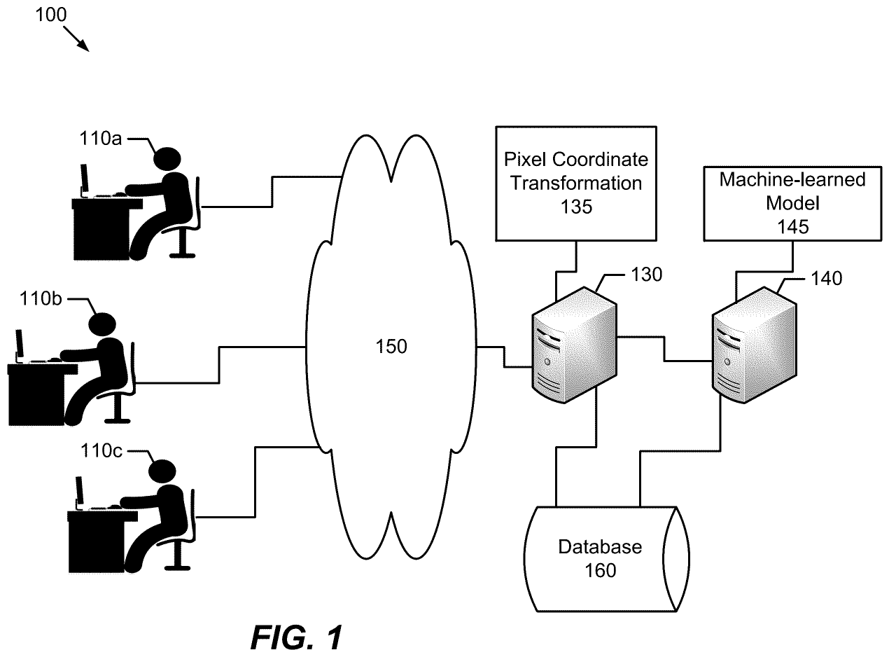

Referring to FIG. 1, a communication network 100 including a system for displaying images by transforming image pixel coordinates to a common coordinate system, comprises user entities 110a, 110b, and 110c that may use devices, such as computers, laptops, tables, mobile communication devices (e.g., smart phones), and the like, to view images. The entities 110a, 110b, and 110c may each represent a single person or may each represent multiple persons. For example, a user entity may be representative of a committee that works together in viewing images. In some embodiments, the entities 110a, 110b, and 110c may be providers that review images, such as X-rays, MRIs, CT scans, and the like for patients, medical studies, or other applications.

An image viewing system includes a pixel coordinate transformation server 130 that is configured to generate images for display in which the image pixels for region of interest in at least one of the images as been transformed to a common coordinate system that is shared with at least one of the other images. The images may be received, for example, from a database 160 directly or, in other embodiments, by way of an Artificial Intelligence (AI) server 140 including a machine-learned model 145 that executes thereon and is trained to detect a region of interest in a volumetric object that includes a set of images where a region of interest is associated with at least a subset of the set of images. In some embodiments, the machine-learned model may be configured to create bounding boxes for the detected regions of interest that may correspond to coordinates for the image pixels associated with the detected region of interest. These images with regions of interest detected and identified by bounding boxes may also be stored in the database 160 and may be retrieved therefrom by the pixel coordinate transformation server 130.

The pixel coordinate transformation server 130 includes a pixel coordinate transformation module 135 that is configured to transform the image pixel coordinates of a region of interest in a volumetric object comprising a set of images to a target coordinate system. The user entities 110a, 110b, and 110c may access these images including regions of interest that have been transformed to a target coordinate system for display and review. For example, in the medical field, a user entity may review two images of a patient's heart. The two images may be used to evaluate the progression of heart disease. The two images, however, are generated at different times and have different image pixel coordinate systems. The image pixel coordinates of the patient's heart taken at a later time may be transformed into the coordinate system of the image of the patient's heart at an earlier time or vice versa. This may alleviate the processing involved of navigating and manipulating one of the two images so that the heart object in the two images line up with each other. This may increase the efficiency of the processing of the two images for display and improve the efficiency of the user entities 110a, 110b, and 110c reviewing the images. Another medical example may be applicable to a teaching environment. A user entity may review two images: one of a patient's heart who has heart disease and a second image of a heart of a healthy individual. The two images were generated at different times and have different image pixel coordinate systems. The image pixel coordinates of the patient's heart with heart disease may be transformed into the coordinate system of the image of the heart of the healthy individual or vice versa. Similar benefits and advantages may follow as described in the previous example where the images correspond to the same patient.

A network 150 couples the user entities 110a, 110b, and 110c to the pixel coordinate transformation server 130 server 130/pixel coordinate transformation module 135. The network 150 may be a global network, such as the Internet or other publicly accessible network. Various elements of the network 150 may be interconnected by a wide area network, a local area network, an Intranet, and/or other private network, which may not be accessible by the general public. Thus, the communication network 150 may represent a combination of public and private networks or a virtual private network (VPN). The network 150 may be a wireless network, a wireline network, or may be a combination of both wireless and wireline networks.

The system for displaying images by transforming image pixel coordinates to a common coordinate system provided through the pixel coordinate transformation server 130 server 130/pixel coordinate transformation module 135 and the AI server 140/machine learned model 145, in some embodiments, may be embodied as a cloud service. In some embodiments, the AI system and labeling service may be implemented as a Representational State Transfer Web Service (RESTful Web service).

Although FIG. 1 illustrates an example communication network including a system for displaying images by transforming image pixel coordinates to a common coordinate system, it will be understood that embodiments of the disclosure are not limited to such configurations, but are intended to encompass any configuration capable of carrying out the operations described herein.

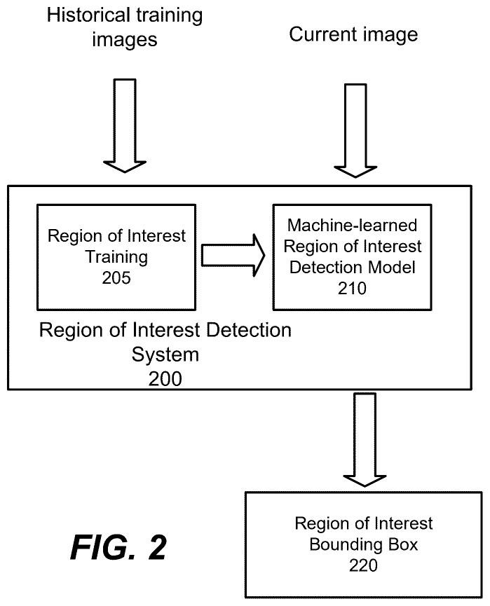

As shown in FIG. 2, the AI server 140 may provide a region of interest detection system 200. The region of interest training module 205 is configured to receive historical training images that include regions of interest of the type to be detected. For example, in a health care application, the training images may be images of a particular body part or area of interest of the human body. The training process generates learned associations between objects in the images and an identification of the region of interest, e.g., a characterization of the region of interest type. Based on these learned associations machine-learned region of interest detection model 210 is generated, which corresponds to the machine-learned model 145 of FIG. 1. When operating in inference mode, the machine-learned region of interest detection model 210 is applied to a new image to detect the object therein and, in some embodiments, generate a bounding box 220 for the region of interest, which defines the image pixel coordinates for the region of interest. In some embodiments, the machine-learned region of interest detection model 210 may associate a label with the bounding box that identifies a type or other type of identifier for the region of interest within the bounding box. For example, the machine-learned region of interest detection model 210 may output more than one bounding box for one or more images. In a chest scan, for example, bounding boxes may be generated for both the heart and lungs, respectively. The labels be used to ensure that when regions of interest are being compared they correspond to the same type of object. The object training module 205 may perform the training and the machine-learned region of interest detection model 210 may operate in inference mode on a same set of one or more processors. In other embodiments, the region of interest training module 205 may perform the training operations using one or more processors included in a first computing entity and the machine-learned region of interest detection model 210 may operate in inference mode using one or more processors included in a second computing entity different from the first computing entity.

In some embodiments, the features of the objects in the historical training images used during training of the machine-learned region of interest detection model 210 may be evaluated to determine their relative impact on the accuracy in identifying region of interest in an image. One or more features or entire images having a lesser impact on the region of interest identification accuracy than other features may be removed from the historical images to reduce the overall dimensionality of the training data set used to train the machine-learned region of interest detection model. Similarly, these features may be removed from the current image, e.g., the image may be edited or cropped, during inference mode to reduce the dimensionality of the features used by the machine-learned region of interest detection model 210 to generate the image with the detected region of interest and bounding box 220. By sparsifying the features used during training and/or during inference mode of the machine-learned region of interest detection model 210, the model may execute on one or more processors with decreased memory and computational requirements (e.g., processor speed and availability).

In some embodiments in which the machine-learned region of interest detection model 210 comprises a neural network, one or more nodes or paths of the neural network may be removed through setting certain parameters or weights to zero based on the sparsification of the features used during training and during inference mode. As a result, the sparsified neural network may run more efficiently and use fewer memory resources.

In some embodiments, one or more of the features used in training or during inference mode of the machine-learned region of interest detection model 210 may be selected to have different quantization levels, e.g., 64-bit, 32-bit, etc. to reduce the size and complexity of the machine-learned object detection model 210. For example, the number of pixels in a training image and/or a current image (inference mode) may be reduced to reduce the quantization level. The quantization level may be adjusted to achieve a desired object detection success rate.

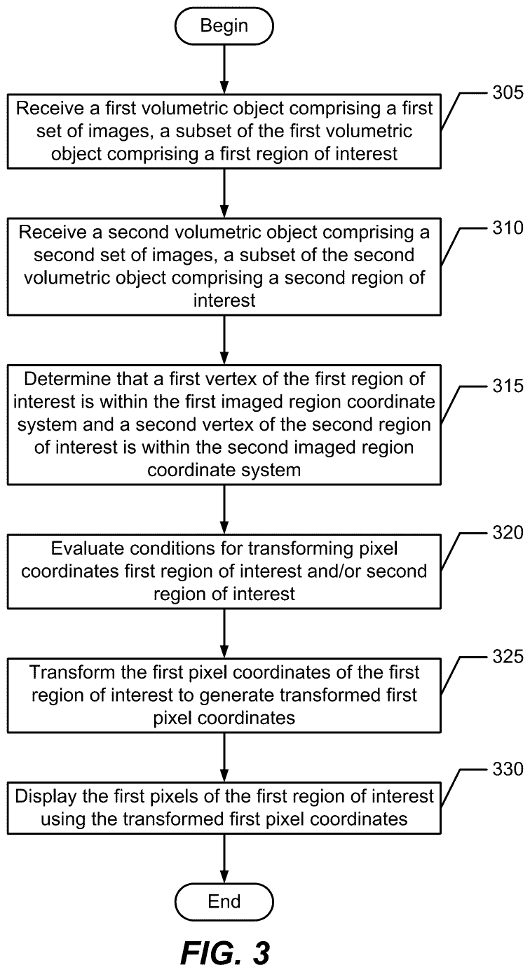

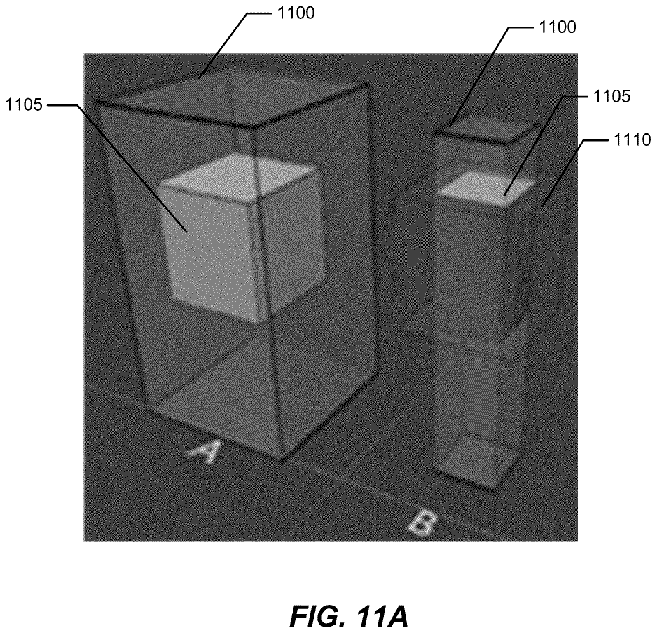

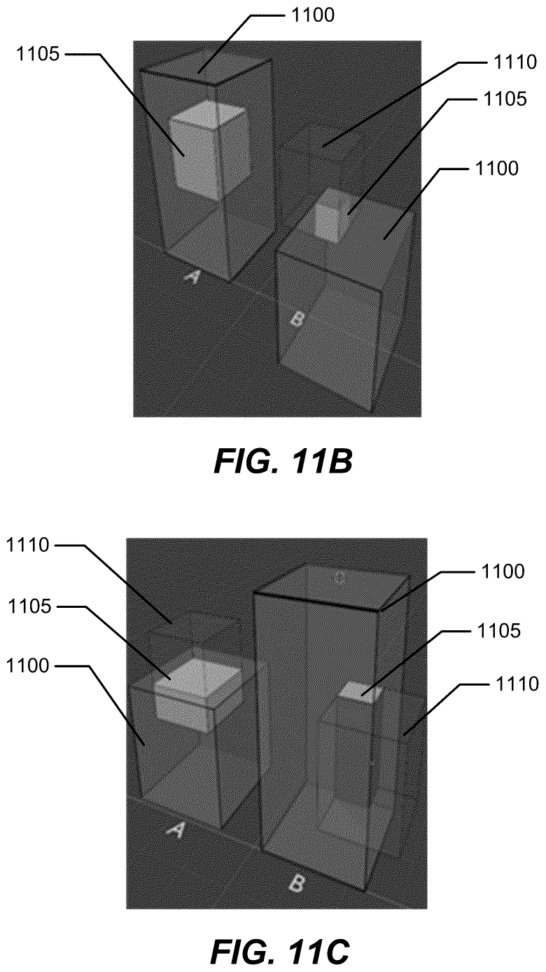

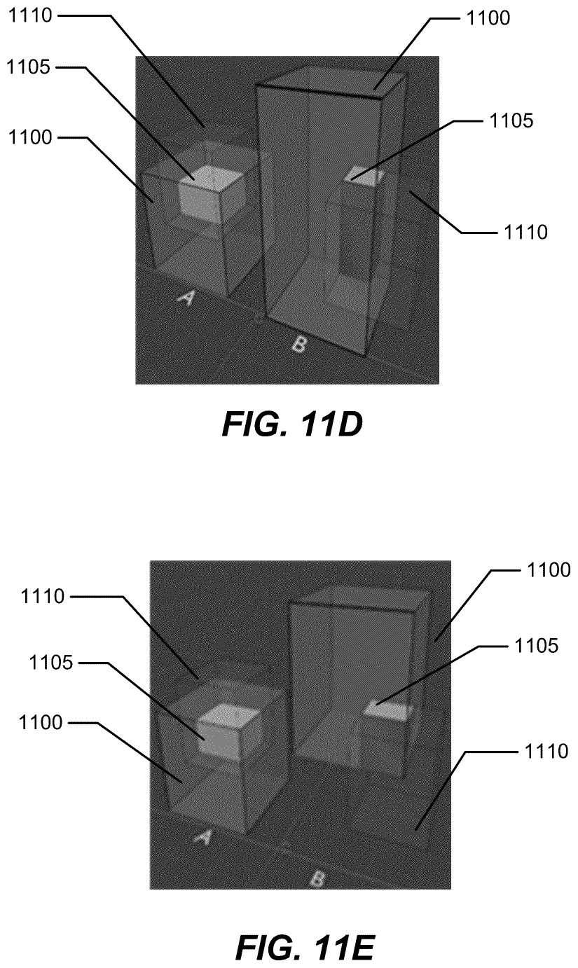

FIG. 3-5 are flowcharts that illustrate operations for transforming image pixel coordinates to a common coordinate system in accordance with some embodiments of the disclosure. Operations being at block 305 where a first volumetric object comprising a first set of images where a subset of the first volumetric object comprises a first region of interest associated with at least a subset of the first set of images is received. A second volumetric object comprising a second set of images where a subset of the second volumetric object comprises a second region of interest associated with at least a subset of the second set of images is received at block 310. Pixels of the first set of images are associated with a first imaged region coordinate system and pixels of the second set of images are associated with a second imaged region coordinate system. To display the first and second regions of interest using a common coordinate system, a determination is made at block 315 that a vertex of the first region of interest is within the first imaged region coordinate system and a vertex of the second imaged region coordinate system is within the second imaged region coordinate system. The pixel coordinates of the first region of interest and/or the pixel coordinates of the second region of interest may be transformed to allow for the first and second regions of interest to be displayed together if either of the two following conditions are satisfied as determined at block 320: 1) a combination of the first region of interest and the second region of interest includes complete edges in three dimensions that are within the first imaged region coordinate system or the second imaged region coordinate system, respectively; and 2) the first region of interest or the second region of interest incudes a complete edge in one of the three dimensions that is within the first imaged region coordinate system or the second imaged region coordinate system, respectively. Evaluating these conditions may be illustrated by way of example with reference to FIG. 11A-11E. In FIG. 11A-11E, two studies A and B are shown in which the imaged regions are denoted with the label 1100, the regions of interest are identified with a bounding box with the label 1105, and the portion of a region of interest 1105 that extends beyond the imaged region coordinate system is identified with the label 1110. This is an imagined region illustrating where the bounding box would extend if it were to cover the entire region of interest, e.g., an entire body part under study. Referring now to FIG. 11A, the two studies A and B cannot be displayed together using a common coordinate system because the region of interest 1105 in study B does not contain a vertex within the imaged region 1100. Instead, the vertices of the region of interest 1105 are outside of the imaged region 1100 as illustrate by the portion 1110. In FIG. 11B, it is possible to display the studies A and B using a common coordinate system because the region of interest 1105 of study A has complete edges in all three dimensions within the image region 1100 even though the region of interest 1105 of study B does not have any edge in any dimension within the imaged region 1100. In FIG. 11C, it is possible to display the studies A and B using a common coordinate system because the region of interest 1105 of study A has edges for length and width within the imaged region 1100 and study B has an edge for height within the imaged region 1100. As a result, the two regions of interest 1105 of studies A and B, combined, include complete edges in three dimensions that are within the first and second imaged regions 1100, respectively, thereby satisfying the first condition set forth above. In FIG. 11D, the regions of interest 1105 for studies A and B can be displayed using a common coordinate system. Although the regions of interest 1105 for studies A and B do not in combination include complete edges in all three dimensions; however, the region of interest 1105 of study B includes a complete edge in the height dimension that is within the imaged region 1100. As a result, the second condition set forth above, i.e., that one of the first region of interest or the second region of interest incudes a complete edge in one of the three dimensions that is within the first imaged region coordinate system or the second imaged region coordinate system, respectively, is satisfied. In FIG. 11E, the two studies A and B cannot be displayed together using a common coordinate system because neither of the two regions of interest 1105 include a complete edge that is within its respective study's imaged region 1100 as shown by the portions 1110 that are outside the imaged regions 1100 for both studies A and B. Returning to FIG. 3, the pixel coordinates of the first region of interest and/or the pixel coordinates of the second region of interest may be transformed at block 325 if either of the conditions described above with and illustrated respect to FIG. 11A-11E are satisfied to allow for the first and second regions of interest to be displayed together at block 330.

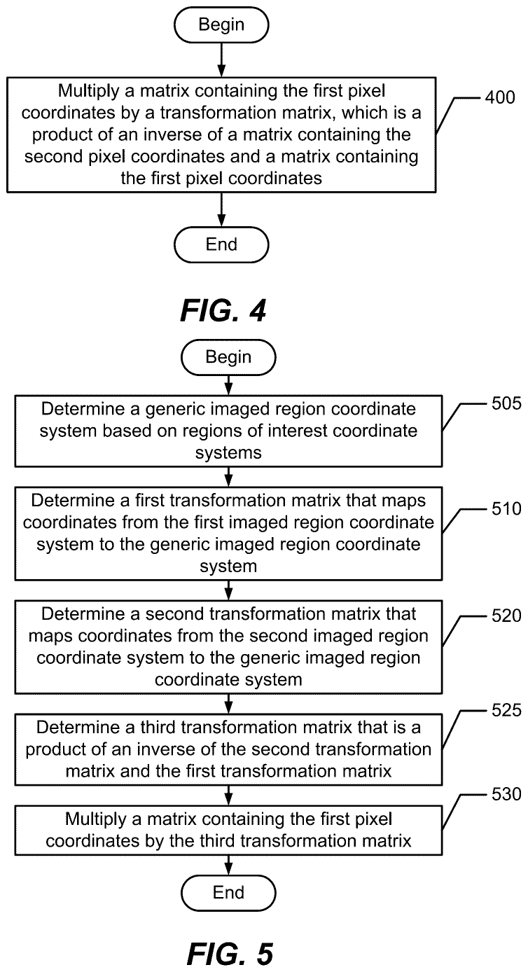

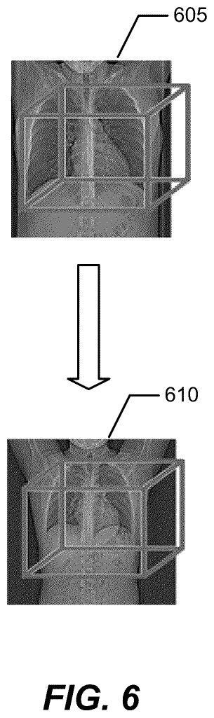

The flowchart of FIG. 4 and the block diagram of FIG. 6 illustrates an example in which a combination of the first region of interest and the second region of interest includes complete edges in three dimensions that are within the first imaged region coordinate system or the second imaged region coordinate system, respectively. Referring to FIG. 4, the first image pixel coordinates of the first region of interest in the first volumetric object are transformed through a multiplication operation using a matrix containing the first pixel coordinates of the first region of interest and a transformation matrix at block 400. The transformation matrix is a product of an inverse of a matrix containing the second pixel coordinates of the second region of interest and a matrix containing the first pixel coordinates of the first region of interest. The transformation matrix may be expressed as T_{o,first,second}=T⁻¹_{o,second}*T_{o,first}, where O represents the region of interest, first represents the first pixel coordinates of the first region of interest, and second represents the second pixel coordinates of the second region of interest. In some embodiments, the first pixel coordinates of the first region of interest may be scaled as part of the transformation. FIG. 6 illustrates this transformation where the image pixels of a first region of interest 605 highlighted by a bounding box in a first volumetric object are directly transformed into a second coordinate system space corresponding to image pixels of a second region of interest 610.

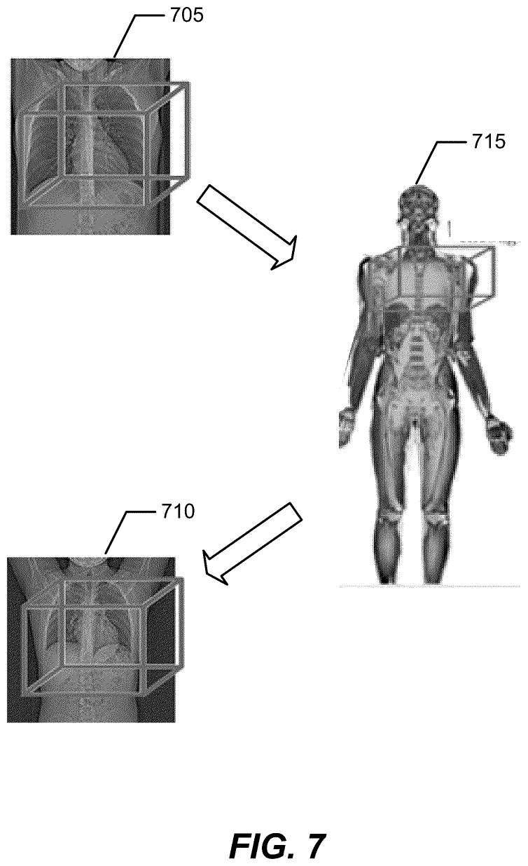

The flowchart of FIG. 5 and the block diagram of FIG. 7 illustrates an example in which the first condition set forth above is not satisfied, but the second condition is satisfied, i.e., one of the first region of interest or the second region of interest incudes a complete edge in one of the three dimensions that is within the first imaged region coordinate system or the second imaged region coordinate system, respectively. In this example, a new coordinate system space is used as an interface between the two imaged region coordinate systems. Referring now to FIG. 5, operations begin at block 505 where a generic coordinate system is determined that encompasses the coordinate systems of the first and second regions of interest, respectively. For example, when the regions of interest correspond to a body region, the generic coordinate system may be created based on the median x, y, z aspect ratios for each instance of the body region in a general patient population. A first transformation matrix that maps coordinates from the first imaged region coordinate system to the generic coordinate system is determined at block 510 and a second transformation matrix that maps coordinates from the second imaged region coordinate system to the generic coordinate system is determined at block 520. A third transformation matrix is determined as a product of an inverse of the second transformation matrix and the first transformation matrix. The first pixel coordinates of a first region of interest are transformed at block 530 from the first imaged region coordinate system to the generic coordinate system by multiplying a matrix containing the first imaged region pixel coordinates by the third transformation matrix. A similar operation may be performed to transform second pixel coordinates of a second region of interest from a second imaged region coordinate system to the generic coordinate system. In some embodiments, scaling of the first pixel coordinates or second pixel coordinates may be performed for a more accurate mapping into the generic coordinate space. The third transformation matrix may be expressed as T_{o,first,second}=T⁻¹_{o,second,generic}*T_{o,first,generic}, where O represents the region of interest, first represents the first pixel coordinates of the first region of interest, second represents the second pixel coordinates of the second region of interest, generic represents the generic coordinate system, and T_{o,c1,c2} represents a transformation matrix from a volume V_{o,c1} to V_{o,c2} in coordinate systems c1 and c2. FIG. 7 illustrates this transformation where the image pixels of a first region of interest highlighted by a bounding box in a first volumetric object 705 are transformed into a generic coordinate space 715. And then from the generic coordinate space 715 to a second region of interest in a second volumetric object 710.

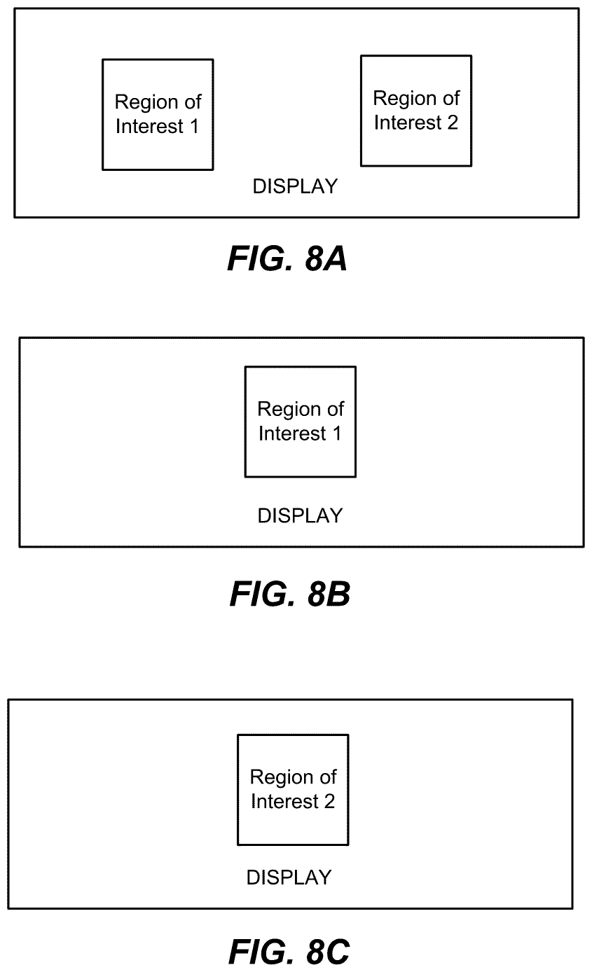

FIGS. 8A, 8B, and 8C are block diagrams that illustrate displaying regions of interest of volumetric objects in which one or both of the regions of interest has image pixel coordinates that have been transformed to a common coordinate system in accordance with some embodiments of the disclosure. As shown in FIG. 8A, a first region of interest in which the image pixels of the first region of interest of a first volumetric object have been transformed into the coordinate space of a second region of interest of a second volumetric object or both of the first and second regions of interest have had their pixel coordinates transformed to a generic coordinate space are displayed simultaneously on the display allowing a user more readily compare the first region of interest with the second region of interest without the need for navigation in either of the two images containing the first and second regions of interest, respectively, so that the first region of interest and the second region of interest are displayed together and can be compared. Nevertheless, the two regions of interest may be displayed individually as shown in FIGS. 8B and 8C.

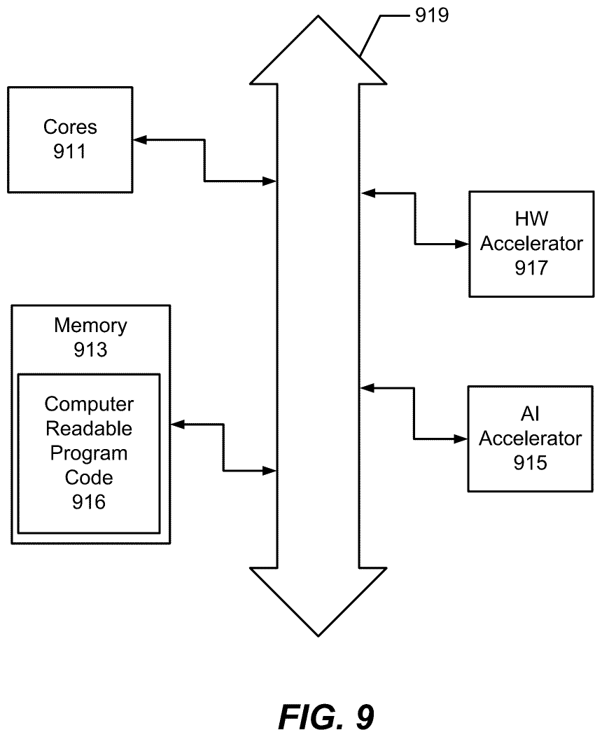

FIG. 9 is a data processing system that may be used to implement a system for displaying images by transforming image pixel coordinates to a common coordinate system in accordance with some embodiments of the disclosure. For example, the data processing system of FIG. 9 may be used to implement the pixel coordinate transformation server 130 of FIG. 1, the AI server 140 of FIG. 1, and/or the object detection system 200 of FIG. 2. As shown in FIG. 9, the data processing system may include at least one core 911, a memory 913, an artificial intelligence (AI) accelerator 915, and a hardware (HW) accelerator 917. The at least one core 911, the memory 913, the AI accelerator 915, and the HW accelerator 917 may communicate with each other through a bus 919.

The at least one core 911 may be configured to execute computer program instructions. For example, the at least one core 911 may execute an operating system and/or applications represented by the computer readable program code 916 stored in the memory 913. In some embodiments, the at least one core 911 may be configured to instruct the AI accelerator 915 and/or the HW accelerator 917 to perform operations by executing the instructions and obtain results of the operations from the AI accelerator 915 and/or the HW accelerator 917. In some embodiments, the at least one core 911 may be an Application Specific Instruction Set Processor (ASIP) customized for specific purposes and support a dedicated instruction set.

The memory 913 may have an arbitrary structure configured to store data. For example, the memory 913 may include a volatile memory device, such as dynamic random-access memory (DRAM) and static RAM (SRAM), or include a non-volatile memory device, such as flash memory and resistive RAM (RRAM). The at least one core 911, the AI accelerator 915, and the HW accelerator 917 may store data in the memory 913 or read data from the memory 913 through the bus 919.

The AI accelerator 915 may refer to hardware designed for AI applications. In some embodiments, the AI accelerator 915 may include a machine-learned model and/or other AI models configured to facilitate operations associated with displaying objects in which one of the objects has image pixel coordinates that have been transformed to a common coordinate system as described above with respect to FIGS. 1-8. The AI accelerator 915 may generate output data by processing input data provided from the at least one core 915 and/or the HW accelerator 917 and provide the output data to the at least one core 911 and/or the HW accelerator 917. In some embodiments, the AI accelerator 915 may be programmable and be programmed by the at least one core 911 and/or the HW accelerator 917. The HW accelerator 917 may include hardware designed to perform specific operations at high speed. The HW accelerator 917 may be programmable and be programmed by the at least one core 911.

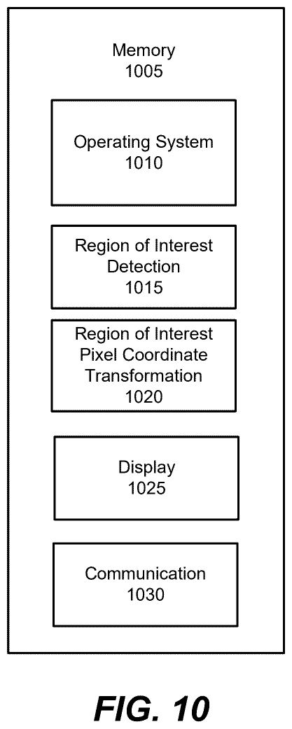

FIG. 10 illustrates a memory 1005 that may be used in embodiments of data processing systems, such as the pixel coordinate transformation server 130 of FIG. 1, the AI server 140 of FIG. 1, the region of interest detection system 200 of FIG. 2, and/or the data processing system of FIG. 9 to facilitate displaying images by transforming image pixel coordinates to a common coordinate system in accordance with some embodiments of the disclosure. The memory 1005 is representative of the one or more memory devices containing the software and data used for facilitating operations of the pixel coordinate transformation server 130 of FIG. 1, the AI server 140 of FIG. 1, and/or the region of interest detection system 200 of FIG. 2 as described herein. The memory 1005 may include, but is not limited to, the following types of devices: cache, ROM, PROM, EPROM, EEPROM, flash, SRAM, and DRAM. As shown in FIG. 10, the memory 1005 may contain five or more categories of software and/or data: an operating system 1010, a region of interest detection module 1015, a region of interest coordinate transformation module 1020, a display module 1025, and a communication module 1030. In particular, the operating system 1010 may manage the data processing system's software and/or hardware resources and may coordinate execution of programs by the processor. The region of interest detection module 1015 may be configured to perform one or more of the operations described above with respect to the AI server 140 of FIG. 1, the region of interest detection system 200 of FIG. 2, the flowcharts of FIG. 3-5, the block diagrams of FIGS. 6 and 7, and the block diagrams of FIG. 11A-11E. The region of interest coordination transformation module 1020 may be configured to perform one or more of the operations described above with respect to the pixel coordinate transformation server 130 of FIG. 1, the flowcharts of FIG. 3-5, the block diagrams of FIGS. 6 and 7, and the block diagrams of FIG. 11A-11E. The display module 1025 may be configured to perform one or more of the operations described above with respect to the pixel coordinate transformation server 130 of FIG. 1, the flowcharts of FIG. 3-5, and the block diagrams of FIGS. 6, 7, 8A, 8B, and 8C. The communication module 1030 may be configured to facilitate communication between the entities 110a, 110b, and 110c, the pixel coordinate transformation server 130 of FIG. 1, the AI server 140 of FIG. 1, and/or the region of interest detection system 200 of FIG. 2

Although FIG. 10 illustrates hardware/software architectures that may be used in data processing systems, such as the pixel coordinate transformation server 130 of FIG. 1, the AI server 140 of FIG. 1, the region of interest detection system 200 of FIG. 2, and/or the data processing system of FIG. 9, respectively, in accordance with some embodiments of the disclosure, it will be understood that embodiments of the present disclosure are not limited to such a configuration but is intended to encompass any configuration capable of carrying out operations described herein.

Computer program code for carrying out operations of data processing systems discussed above with respect to FIG. 1-10 and 11A-11E may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the pixel coordinate transformation server 130 of FIG. 1, the AI server 140 of FIG. 1, the region of interest detection system 200 of FIG. 2, and/or the data processing system of FIG. 9 may each be implemented as a single processor system, a multi-processor system, a multi-core processor system, or even a network of stand-alone computer systems, in accordance with various embodiments of the disclosure. Each of these processor/computer systems may be referred to as a “processor” or “data processing system.” The functionality provided by each of the pixel coordinate transformation server 130 of FIG. 1, the AI server 140 of FIG. 1, the region of interest detection system 200 of FIG. 2, and/or the data processing system of FIG. 9 may be embodied as a single server or embodied as separate servers in accordance with different embodiments of the disclosure.

The data processing apparatus described herein with respect to FIGS. 1-9 and FIG. 11A-11E may be used to facilitate displaying images by transforming image pixel coordinates to a common coordinate system in accordance with some embodiments of the disclosure. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 913 and memory 1005 when coupled to a processor includes computer readable program code that, when executed by the processor, causes the processor to perform operations including one or more of the operations described herein with respect to FIG. 1-7, 8A, 8B, and 8C, and 11A-11E.

Some embodiments of the disclosure may provide systems and methods for displaying images by transforming image pixel coordinates to a common coordinate system as set forth by the following examples: Example 1: a computer-implemented method comprises receiving, by one or more processors, a first volumetric object comprising a first set of images, a subset of the first volumetric object comprising a first region of interest associated with at least a subset of the first set of images, pixels of the first set of images being associated with a first imaged region coordinate system; receiving, by the one or more processors, a second volumetric object comprising a second set of images, a subset of the second volumetric object comprising a second region of interest associated with at least a subset of the second set of images, pixels of the second set of images being associated with a second imaged region coordinate system; determining, by the one or more processors, that a first vertex of the first region of interest is within the first imaged region coordinate system and a second vertex of the second region of interest is within the second imaged region coordinate system; determining, by the one or more processors, that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively; transforming, by the one or more processors, first pixel coordinates of the first region of interest to generate transformed first pixel coordinates based on the first pixel coordinates of the first region of interest and second pixel coordinates of the second region of interest; and displaying, by the one or more processors, first pixels of the first region of interest using the transformed first pixel coordinates.

Example 2: the computer-implemented method of Example 1, wherein the combination of the first region of interest and the second region of interest includes complete edges in three dimensions that are within the first imaged region coordinate system or the second imaged region coordinate system, respectively; wherein transforming the first pixel coordinates of the first region of interest comprises: multiplying, by the one or more processors, a matrix containing the first pixel coordinates by a transformation matrix.

Example 3: the computer-implemented method of Example 2, wherein the transformation matrix is a product of an inverse of a matrix containing the second pixel coordinates and the matrix containing the first pixel coordinates; and wherein displaying the first pixels of the first region of interest comprises: displaying, by the one or more processors, the first pixels of the first region of interest using the transformed first pixel coordinates and second pixels of the second region of interest using the second pixel coordinates of the second region of interest.

Example 4: the computer-implemented method of Example 1, wherein the first region of interest or the second region of interest includes the complete edge in one of the three dimensions that is within the first imaged region coordinate system or the second imaged region coordinate system; wherein transforming the first pixel coordinates of the first region of interest comprises: determining, by the one or more processors, a generic imaged region coordinate system; determining, by the one or more processors, a first transformation matrix that maps coordinates from the first imaged region coordinate system to the generic imaged region coordinate system; determining, by the one or more processors, a second transformation matrix that maps coordinates from the second imaged region coordinate system to the generic imaged region coordinate system; and determining, by the one or more processors, a third transformation matrix as a product of an inverse of the second transformation matrix and the first transformation matrix.

Example 5: the computer-implemented method of Example 4, wherein transforming the first pixel coordinates of the first region of interest comprises: scaling, by the one or more processors, the first pixel coordinates of the first region of interest; multiplying, by the one or more processors, a matrix containing the scaled first pixel coordinates by the third transformation matrix.

Example 6: the computer-implemented method of Examples 1-5, wherein displaying the first pixels of the first region of interest comprises: displaying, by the one or more processors, the first pixels of the first region of interest and second pixels of the second region of interest simultaneously on a same display.

Example 7: the computer-implemented method of Examples 1-6, further comprising: detecting, by the one or more processors and using a machine learned system, the first region of interest in the first volumetric object; generating, by the one or more processors, a first bounding box for the first region of interest; determining, by the one or more processors, the first pixel coordinates based on the first bounding box; detecting, by the one or more processors and using the machine learned system, the second region of interest in the second volumetric object; generating, by the one or more processors, a second bounding box for the second region of interest; and determining, by the one or more processors, the second pixel coordinates based on the second bounding box.

Example 8: the computer-implemented method of Examples 1-7, wherein the first region of interest and the second region of interest are a same type of region.

Example 9, the computer-implemented method of Example 8, wherein the type of region is a human body part.

Example 10, a system comprises one or more processors; and one or more memories storing process-executable instructions that, when executed by the one or more processors, cause the one or more processors to perform operations comprising: receiving a first volumetric object comprising a first set of images, a subset of the first volumetric object comprising a first region of interest associated with at least a subset of the first set of images, pixels of the first set of images being associated with a first imaged region coordinate system; receiving a second volumetric object comprising a second set of images, a subset of the second volumetric object comprising a second region of interest associated with at least a subset of the second set of images, pixels of the second set of images being associated with a second imaged region coordinate system; determining that a first vertex of the first region of interest is within the first imaged region coordinate system and a second vertex of the second region of interest is within the second imaged region coordinate system; determining that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively; transforming first pixel coordinates of the first region of interest to generate transformed first pixel coordinates based on the first pixel coordinates of the first region of interest and second pixel coordinates of the second region of interest; and displaying first pixels of the first region of interest using the transformed first pixel coordinates.

Example 11, the system of Example 10, wherein the combination of the first region of interest and the second region of interest includes complete edges in three dimensions that are within the first imaged region coordinate system or the second imaged region coordinate system, respectively; wherein transforming the first pixel coordinates of the first region of interest comprises: multiplying a matrix containing the first pixel coordinates by a transformation matrix.

Example 12, the system of Example 11, wherein the transformation matrix is a product of an inverse of a matrix containing the second pixel coordinates and the matrix containing the first pixel coordinates; and wherein displaying the first pixels of the first region of interest comprises: displaying the first pixels of the first region of interest using the transformed first pixel coordinates and second pixels of the second region of interest using the second pixel coordinates of the second region of interest.

Example 13, the system of Example 12, wherein the first region of interest or the second region of interest includes the completed edge in one of the three dimensions that is within the first imaged region coordinate system or the second imaged region coordinate system; wherein transforming the first pixel coordinates of the first region of interest comprises: determining a generic imaged region coordinate system; determining a first transformation matrix that maps coordinates from the first imaged region coordinate system to the generic imaged region coordinate system; determining a second transformation matrix that maps coordinates from the second imaged region coordinate system to the generic imaged region coordinate system; and determining a third transformation matrix as a product of an inverse of the second transformation matrix and the first transformation matrix.

Example 14, the system of Example 13, wherein transforming the first pixel coordinates of the first region of interest comprises: scaling the first pixel coordinates of the first region of interest; and multiplying a matrix containing the scaled first pixel coordinates by the third transformation matrix.

Example 15, the system of Examples 10-14, wherein displaying the first pixels of the first region of interest comprises: displaying the first pixels of the first region of interest and second pixels of the second region of interest simultaneously on a same display.

Example 16: one or more non-transitory computer-readable media store processor-executable instructions that, when executed by one or more processors, cause the one or more processors to perform operations comprising: receiving a first volumetric object comprising a first set of images, a subset of the first volumetric object comprising a first region of interest associated with at least a subset of the first set of images, pixels of the first set of images being associated with a first imaged region coordinate system; receiving a second volumetric object comprising a second set of images, a subset of the second volumetric object comprising a second region of interest associated with at least a subset of the second set of images, pixels of the second set of images being associated with a second imaged region coordinate system; determining that a first vertex of the first region of interest is within the first imaged region coordinate system and a second vertex of the second region of interest is within the second imaged region coordinate system; determining that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively; transforming first pixel coordinates of the first region of interest to generate transformed first pixel coordinates based on the first pixel coordinates of the first region of interest and second pixel coordinates of the second region of interest; and displaying first pixels of the first region of interest using the transformed first pixel coordinates.

Example 17: the one or more non-transitory computer-readable media of Example 16, wherein the combination of the first region of interest and the second region of interest includes complete edges in three dimensions that are within the first imaged region coordinate system or the second imaged region coordinate system, respectively; wherein transforming the first pixel coordinates of the first region of interest comprises: multiplying a matrix containing the first pixel coordinates by a transformation matrix.

Example 18, the one or more non-transitory computer-readable media of Example 17, wherein the transformation matrix is a product of an inverse of a matrix containing the second pixel coordinates and the matrix containing the first pixel coordinates; and wherein displaying the first pixels of the first region of interest comprises: displaying the first pixels of the first region of interest using the transformed first pixel coordinates and second pixels of the second region of interest using the second pixel coordinates of the second region of interest.

Example 19, the one or more non-transitory computer-readable media of Example 16, wherein the first region of interest or the second region of interest includes the completed edge in one of the three dimensions that is within the first imaged region coordinate system or the second imaged region coordinate system; wherein transforming the first pixel coordinates of the first region of interest comprises: determining a generic imaged region coordinate system; determining a first transformation matrix that maps coordinates from the first imaged region coordinate system to the generic imaged region coordinate system; determining a second transformation matrix that maps coordinates from the second imaged region coordinate system to the generic imaged region coordinate system; and determining a third transformation matrix as a product of an inverse of the second transformation matrix and the first transformation matrix.

Example 20, the one or more non-transitory computer-readable media of Example 19, wherein transforming the first pixel coordinates of the first region of interest comprises: scaling the first pixel coordinates of the first region of interest; and multiplying a matrix containing the scaled first pixel coordinates by the third transformation matrix.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

The embodiments of the present disclosure have been presented for purposes of illustration and description, but are not intended to be exhaustive or limited to the disclosure in the form disclosed. Many modifications and variations may be apparent to those of ordinary skill in the art without departing from the scope and spirit of the disclosure. The aspects of the disclosure herein were chosen and described to best explain the principles of the disclosure and the practical application thereof, and to enable others of ordinary skill in the art to understand the disclosure with various modifications as are suited to the particular use contemplated.

What is claimed is:

1. A computer-implemented method, comprising:
receiving, by one or more processors, a first volumetric object comprising a first set of images, a subset of the first volumetric object comprising a first region of interest associated with at least a subset of the first set of images, pixels of the first set of images being associated with a first imaged region coordinate system;
receiving, by the one or more processors, a second volumetric object comprising a second set of images, a subset of the second volumetric object comprising a second region of interest associated with at least a subset of the second set of images, pixels of the second set of images being associated with a second imaged region coordinate system;
determining, by the one or more processors, that a first vertex of the first region of interest is within the first imaged region coordinate system and a second vertex of the second region of interest is within the second imaged region coordinate system;
determining, by the one or more processors, that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively;
transforming, by the one or more processors, first pixel coordinates of the first region of interest to generate transformed first pixel coordinates based on the first pixel coordinates of the first region of interest and second pixel coordinates of the second region of interest; and
displaying, by the one or more processors, first pixels of the first region of interest using the transformed first pixel coordinates.

2. The computer-implemented method of claim 1, wherein the combination of the first region of interest and the second region of interest includes complete edges in three dimensions that are within the first imaged region coordinate system or the second imaged region coordinate system, respectively;
wherein transforming the first pixel coordinates of the first region of interest comprises:
multiplying, by the one or more processors, a matrix containing the first pixel coordinates by a transformation matrix.

3. The computer-implemented method of claim 2,
wherein the transformation matrix is a product of an inverse of a matrix containing the second pixel coordinates and the matrix containing the first pixel coordinates; and
wherein displaying the first pixels of the first region of interest comprises:
displaying, by the one or more processors, the first pixels of the first region of interest using the transformed first pixel coordinates and second pixels of the second region of interest using the second pixel coordinates of the second region of interest.

4. The computer-implemented method of claim 1, wherein the first region of interest or the second region of interest includes the complete edge in one of the three dimensions that is within the first imaged region coordinate system or the second imaged region coordinate system;
wherein transforming the first pixel coordinates of the first region of interest comprises:
determining, by the one or more processors, a generic imaged region coordinate system;
determining, by the one or more processors, a first transformation matrix that maps coordinates from the first imaged region coordinate system to the generic imaged region coordinate system;
determining, by the one or more processors, a second transformation matrix that maps coordinates from the second imaged region coordinate system to the generic imaged region coordinate system; and
determining, by the one or more processors, a third transformation matrix as a product of an inverse of the second transformation matrix and the first transformation matrix.

5. The computer-implemented method of claim 4, wherein transforming the first pixel coordinates of the first region of interest comprises:
scaling, by the one or more processors, the first pixel coordinates of the first region of interest; and
multiplying, by the one or more processors, a matrix containing the scaled first pixel coordinates by the third transformation matrix.

6. The computer-implemented method of claim 1, wherein displaying the first pixels of the first region of interest comprises:
displaying, by the one or more processors, the first pixels of the first region of interest and second pixels of the second region of interest simultaneously on a same display.

7. The computer-implemented method of claim 1, further comprising:
detecting, by the one or more processors and using a machine learned system, the first region of interest in the first volumetric object;
generating, by the one or more processors, a first bounding box for the first region of interest;
determining, by the one or more processors, the first pixel coordinates based on the first bounding box;
detecting, by the one or more processors and using the machine learned system, the second region of interest in the second volumetric object;
generating, by the one or more processors, a second bounding box for the second region of interest; and
determining, by the one or more processors, the second pixel coordinates based on the second bounding box.

8. The computer-implemented method of claim 1, wherein the first region of interest and the second region of interest are a same type of region.

9. The computer-implemented method of claim 8, wherein the type of region is a human body part.

10. A system, comprising:
one or more processors; and
one or more memories storing processor-executable instructions that, when executed by the one or more processors, cause the one or more processors to perform operations comprising:
receiving a first volumetric object comprising a first set of images, a subset of the first volumetric object comprising a first region of interest associated with at least a subset of the first set of images, pixels of the first set of images being associated with a first imaged region coordinate system;
receiving a second volumetric object comprising a second set of images, a subset of the second volumetric object comprising a second region of interest associated with at least a subset of the second set of images, pixels of the second set of images being associated with a second imaged region coordinate system;
determining that a first vertex of the first region of interest is within the first imaged region coordinate system and a second vertex of the second region of interest is within the second imaged region coordinate system;
determining that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively;
transforming first pixel coordinates of the first region of interest to generate transformed first pixel coordinates based on the first pixel coordinates of the first region of interest and second pixel coordinates of the second region of interest; and
displaying first pixels of the first region of interest using the transformed first pixel coordinates.

11. The system of claim 10, wherein the combination of the first region of interest and the second region of interest includes complete edges in three dimensions that are within the first imaged region coordinate system or the second imaged region coordinate system, respectively;
wherein transforming the first pixel coordinates of the first region of interest comprises:
multiplying a matrix containing the first pixel coordinates by a transformation matrix.

12. The system of claim 11, wherein the transformation matrix is a product of an inverse of a matrix containing the second pixel coordinates and the matrix containing the first pixel coordinates; and
wherein displaying the first pixels of the first region of interest comprises:
displaying the first pixels of the first region of interest using the transformed first pixel coordinates and second pixels of the second region of interest using the second pixel coordinates of the second region of interest.

13. The system of claim 10, wherein the first region of interest or the second region of interest includes the completed edge in one of the three dimensions that is within the first imaged region coordinate system or the second imaged region coordinate system;
wherein transforming the first pixel coordinates of the first region of interest comprises:
determining a generic imaged region coordinate system;
determining a first transformation matrix that maps coordinates from the first imaged region coordinate system to the generic imaged region coordinate system;
determining a second transformation matrix that maps coordinates from the second imaged region coordinate system to the generic imaged region coordinate system; and
determining a third transformation matrix as a product of an inverse of the second transformation matrix and the first transformation matrix.

14. The system of claim 13, wherein transforming the first pixel coordinates of the first region of interest comprises:
scaling the first pixel coordinates of the first region of interest; and
multiplying a matrix containing the scaled first pixel coordinates by the third transformation matrix.

15. The system of claim 10, wherein displaying the first pixels of the first region of interest comprises:
displaying the first pixels of the first region of interest and second pixels of the second region of interest simultaneously on a same display.

16. One or more non-transitory computer-readable media storing processor-executable instructions that, when executed by one or more processors, cause the one or more processors to perform operations comprising:
receiving a first volumetric object comprising a first set of images, a subset of the first volumetric object comprising a first region of interest associated with at least a subset of the first set of images, pixels of the first set of images being associated with a first imaged region coordinate system;
receiving a second volumetric object comprising a second set of images, a subset of the second volumetric object comprising a second region of interest associated with at least a subset of the second set of images, pixels of the second set of images being associated with a second imaged region coordinate system;
determining that a first vertex of the first region of interest is within the first imaged region coordinate system and a second vertex of the second region of interest is within the second imaged region coordinate system;
determining that a combination of the first region of interest and the second region of interest includes complete edges in three dimensions that are within the first imaged region coordinate system or the second imaged region coordinate system, respectively, or the first region of interest or the second region of interest includes a complete edge in one of the three dimensions that is within the first imaged region coordinate system or the second imaged region coordinate system, respectively;
transforming first pixel coordinates of the first region of interest to generate transformed first pixel coordinates based on the first pixel coordinates of the first region of interest and second pixel coordinates of the second region of interest; and
displaying first pixels of the first region of interest using the transformed first pixel coordinates.

17. The one or more non-transitory computer-readable media of claim 16, wherein the combination of the first region of interest and the second region of interest includes complete edges in three dimensions that are within the first imaged region coordinate system or the second imaged region coordinate system, respectively;
wherein transforming the first pixel coordinates of the first region of interest comprises:
multiplying a matrix containing the first pixel coordinates by a transformation matrix.

18. The one or more non-transitory computer-readable media of claim 17, wherein the transformation matrix is a product of an inverse of a matrix containing the second pixel coordinates and the matrix containing the first pixel coordinates; and
wherein displaying the first pixels of the first region of interest comprises:
displaying the first pixels of the first region of interest using the transformed first pixel coordinates and second pixels of the second region of interest using the second pixel coordinates of the second region of interest.

19. The one or more non-transitory computer-readable media of claim 16, wherein the first region of interest or the second region of interest includes the completed edge in one of the three dimensions that is within the first imaged region coordinate system or the second imaged region coordinate system;
wherein transforming the first pixel coordinates of the first region of interest comprises:
determining a generic imaged region coordinate system;
determining a first transformation matrix that maps coordinates from the first imaged region coordinate system to the generic imaged region coordinate system;
determining a second transformation matrix that maps coordinates from the second imaged region coordinate system to the generic imaged region coordinate system; and
determining a third transformation matrix as a product of an inverse of the second transformation matrix and the first transformation matrix.

20. The one or more non-transitory computer-readable media of claim 19, wherein transforming the first pixel coordinates of the first region of interest comprises:
scaling the first pixel coordinates of the first region of interest; and
multiplying a matrix containing the scaled first pixel coordinates by the third transformation matrix.
